(19) United States
(12) Patent Application Publication
(10) Pub. No.: US 2012/0019011 A1
(43) Pub. Date: Jan. 26, 2012

(54) Security device for garage doors

(76) Inventor: Paul G. Laborde, Placentia, CA (US)

(21) Appl. No.: 13/136,098

(22) Filed: Jul. 21, 2011

Related U.S. Application Data
(60) Provisional application No. 61/366,456, filed on Jul. 21, 2010.

(51) Int. Cl. E05C 19/00

(52) U.S. Cl. 292/1

(57) ABSTRACT

The present invention resides in a garage shield to prevent the unauthorized opening of a garage door. The garage shield has a base plate having a rectangular configuration that is attached to a garage door arm. The garage door arm is pivotally attached to a garage door at one end and pivotally attached to an upper emergency lever housing at the other end. The emergency release lever housing is attached to a garage door open and close carriage with open and close means. The garage shield base plate has a rectangular shape with attachment means for attaching to a garage door arm.

This Application Claims Benefit of Provisional Application, Ser. No. 61/366,456, Filed on Jul. 21, 2010

### BACKGROUND OF THE INVENTION

1. FIELD OF THE INVENTION

The present invention relates to a garage door device to prevent the unauthorized opening of a garage door. Essentially all garage door openers are currently equipped with an emergency overhead release lever. One major safety flaw with garage doors is located at the top of said garage door. An experienced thief or burglar can open a garage door in 10 (ten) seconds or less by pushing the top of the garage door away from the garage header or by placing a wedge between them. A hook shaped wire, for example, is placed through the opening thus created, to engage the overhead release lever of a garage door opener. The garage door is then manually opened by the thief or burglar.

This problem is alleviated by placing a shield between the opening at the top of the garage door and overhead release lever of a garage door opener.

2. DESCRIPTION OF THE PRIOR ART

Numerous devices have been used in the past to secure and prevent garage doors from being opened illegally. For example, U.S. Pat. No. 5,307,653 to DAVIS, entitled “SLIDEBOLT AND PADLOCK SECURITY DEVICES” relates to protective security devices, and more particularly, to security shield devices for covering portions of slidebolts and padlocks locking the slidelocks on doors.

U.S. Pat. No. 4,655,487 to Korn et al., entitled “GARAGE DOOR BOLT WITH STATIONARY PROTECTIVE COVER”, describes an apparatus forming a garage door bolt with a stationary safety cover, in particular, the invention relates to a sliding bolt for a garage door using a padlock to lock the sliding bolt in position.

U.S. Pat. No. 4,437,692 to HALPOFF, entitled “PROTECTIVE HASP FOR PADLOCK” teaches a back plate serving as a slide bolt frame designed to be fastened to a door, such as a garage door to position a latch bolt slidably mounted on pivot tabs on the back plate. A cover plate pivotally mounts the back plate. The cover plate is held in an overlying position protecting a padlock.

U.S. Pat. No. 4,031,719 to KLINGER et al., entitled “LOCK PROTECTIVE DEVICE”, relates to a lock protective device designed to be used with various well known garage door locking units. The units include a sliding bolt secured to a lock housing unit by a padlock. The protective-locking device is mounted over the bolt. The device protects padlocks and related garage door locking units.

As can readily be determined from the foregoing, there is an ongoing research effort to provide security devices for doors, such as garage doors.

### SUMMARY OF THE INVENTION

A garage security device which comprises a security shield, base plate attached to a garage door arm, which is pivotally attached to a garage door at one end. The other end is pivotally attached to an emergency release lever at the other end. The emergency release lever is attached to a garage door open and close carriage with open and close means. The garage shield prevents unauthorized contact, from outside the garage, with the emergency release lever preventing the garage door from being manually opened.

### BRIEF DESCRIPTION OF THE DRAWINGS

The invention will be better understood when consideration is given to the below described detailed description, which makes reference to the annexed drawings wherein:

FIG. 1 is a partial perspective view of the garage shield attached to the garage door arm of a garage door at one end and the bottom of an emergency release housing at the other end.

FIG. 1A is a side cut-away view of the garage shield attached to a garage door arm having a U shaped attachment means.

FIG. 2 is a partial side view of the garage shield herein attached to a garage door arm.

FIG. 3 is a side view of the garage shield with attached stabilizer.

FIG. 4 is a front drawing of the garage shield herein.

FIG. 5 is a side view of the garage shield attached to a garage door arm wherein the garage door arm is attached to an emergency release lever housing at one end and a garage door at the other end. The garage shield contains an L shaped attachment plate with bolts and nuts. An emergency release lever housing is attached to a garage open and close carriage. A side cut-away view is also shown of a garage header.

FIG. 6 is a side view of the garage shield base plate with L shaped attachment plate and bolts and nuts.

FIG. 7 is a partial, cut-away view of the garage shield base plate containing attachment bolts and nuts.

### DETAILED DESCRIPTION OF THE INVENTION

The present invention resides in a garage shield for preventing the unauthorized opening of a garage door.

Embodiments of the garage shield are herein after described with reference to the drawings, in which identical or corresponding parts are indicated by the same reference characters or numbers through the several drawings.

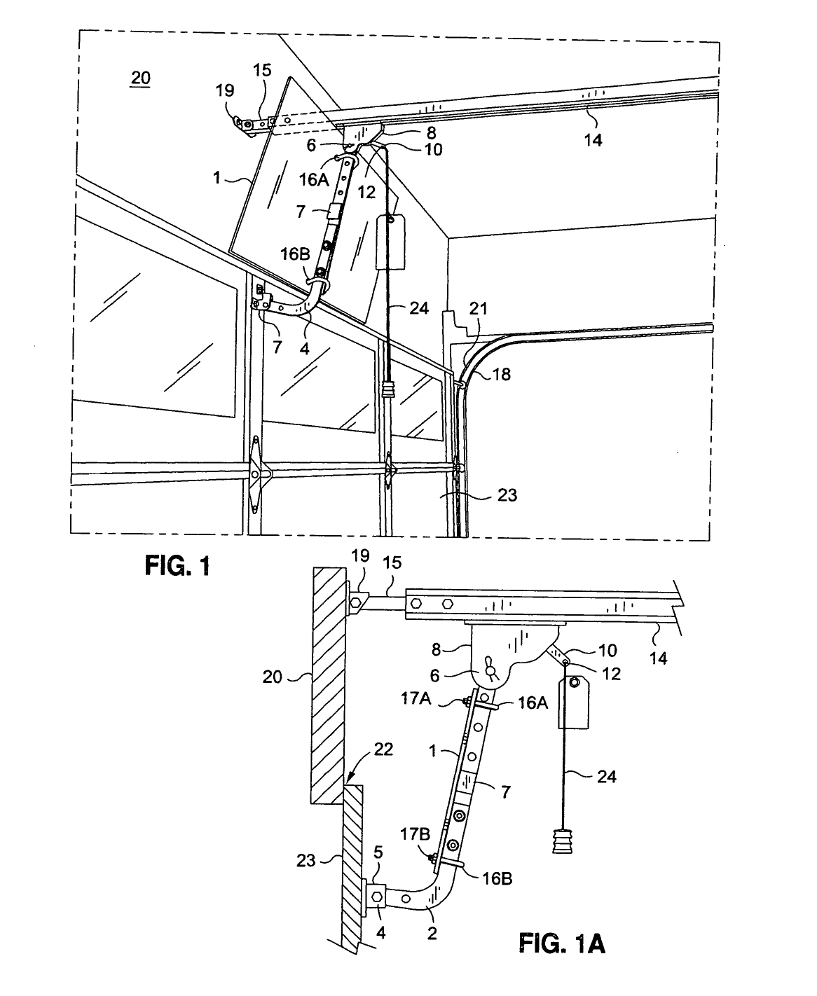

FIG. 1 illustrates a perspective view of a garage shield, base plate (1) attached to garage door arm (7) by U-bolts (16A & 16B) which fit around garage door arm (7) and pass through spaced apart drilled holes in base plate (1). Garage door arm (7) can be either of a solid form or contain spaced apart drilled holes in the side thereof. Garage door arm (7) contains an L-shaped bend (2) at the bottom portion thereof and is attached to garage door anchor (5) with pivotal means (4). Pivotal means (4) consists of a clevis which pivotally passes through the garage door arm (7) and garage door anchor (5). The clevis is secured by a cotter pin. Garage door anchor (5) is attached to garage door (23) by conventional means.

The top portion of garage door arm (7) is attached to the bottom portion of emergency release lever housing (8) with pivotal means (6). Rope (24) is attached to emergency release lever (10) through hole (12). Contained in housing (8). The top of emergency release lever housing (8) is attached to garage door carriage (14) having open and close means. Garage door carriage (14), via carriage support (15), is attached to garage header anchor (19) which is in turn attached to garage header (20) by conventional means.

Garage door (23) is attached to garage door rail (18) with garage door roller (21). It is to be noted that garage door (23) which is a sectional garage door can contain a plurality of garage door rollers (21) as needed.

FIG. 1A is a side, cut-away view of FIG. 1 wherein corresponding numbers and components are substantially as described in FIG. 1, with the following exceptions:

Opening (22) between the bottom of garage header (20) and garage door (23) can be widened by applying pressure on the top of garage door (23). Without garage shield, base plate (1) being attached to garage door arm (7), an individual can pass a thin wire with a hook on it (not shown) through the opening (22) between garage header (20) and garage door (23). The hook of the thin wire can then engage, hole (12) of emergency release lever (10), where a downward pull on the thin wire will disengage emergency release lever (10) from garage carriage (14), thus allowing garage door (23) to be manually opened.

Garage shield, base plate (1) is attached to garage door arm (7) by u-bolts (16A & 16B) with nuts (17A & 17B). Garage shield, base plate (1) is attached to garage door arm (7) at a distance of from about 0.45 inch to 2 inches from the bottom of emergency release lever housing (8), at an angle of 20° degrees to 90° degrees from vertical. Base plate (1) is attached to garage door arm (7) and is positional between garage door (23) and emergency released lever (10).

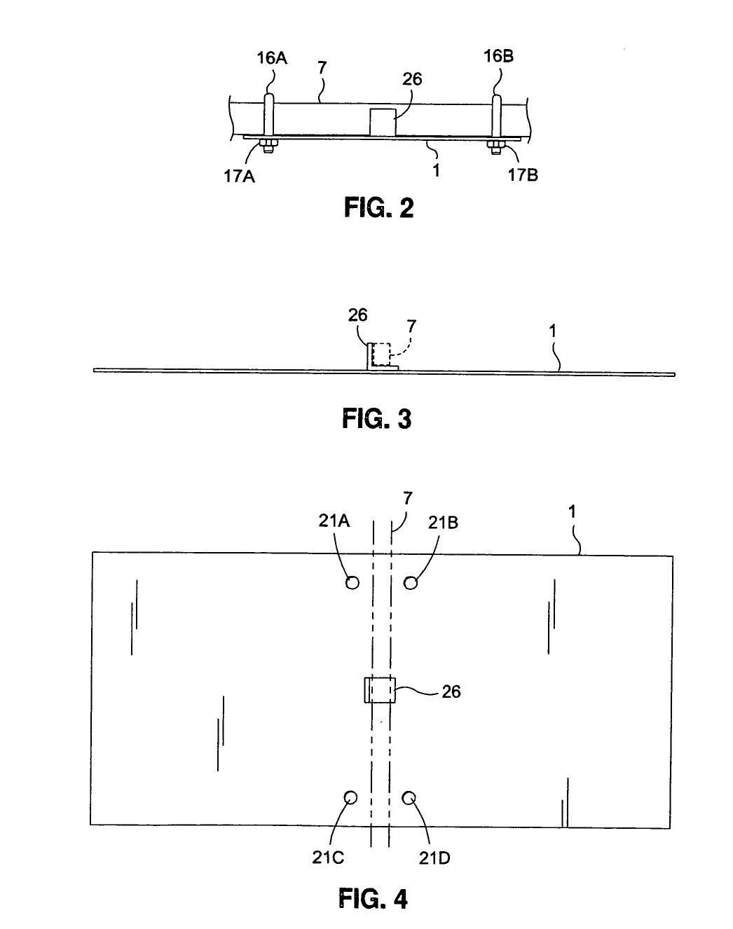

FIG. 2 is a side view of garage shield, base plate (1) attached to garage door arm (7) by u-shaped bolts (16A & 16B) and nuts (17A & 17B). L-shaped stabilizer (26) is attached to base plate (1) which is positioned next to garage door arm (7). Stabilizer (26) can be attached to base plate (1) with adhesives, nuts and bolts, rivets or the like.

FIG. 3 is a side view of FIG. 2, which shows L-shaped stabilizer (26) attached to base plate (1) and resting against garage door arm (7).

FIG. 4 is a front view of garage shield, base plate (1) containing spaced apart holes (21A, 21B, 21C and 21D) for receiving U-shaped bolts and nuts. L-shaped stabilizer (26) is shown resting against garage door arm (7).

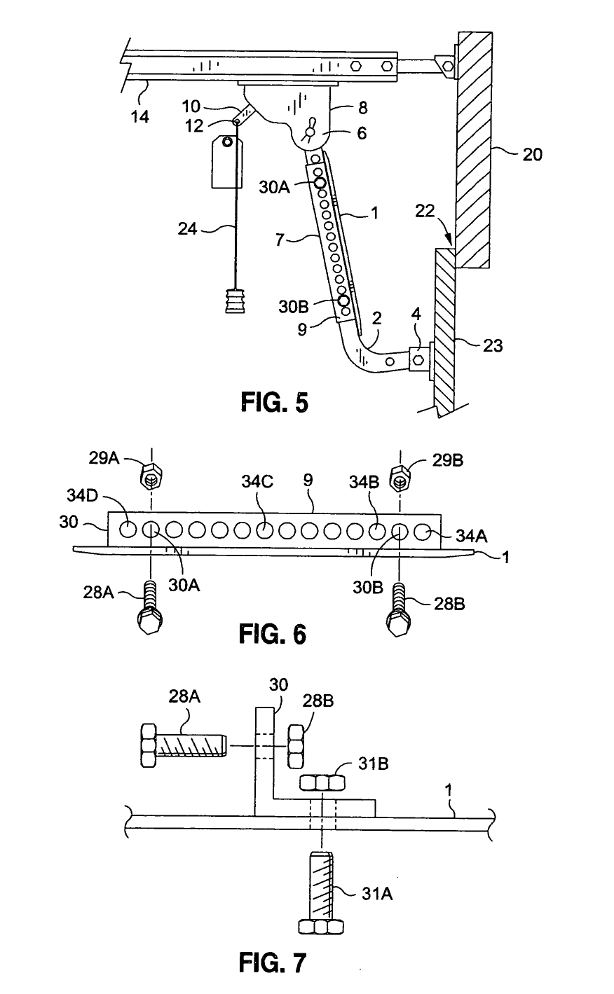

FIG. 5 is a side cut-away view, substantially the same as shown in FIG. 1A, with the following exceptions:

An elongated, L-shaped attachment plate (9) having a plurality of holes (30A & 30B) drilled through it is attached to base plate (1). The L-shaped attachment plate (9) is attached to garage door arm (7).

FIG. 6 is a side view of L-shaped attachment plate (9) containing a plurality of holes (34A, 34B, 34C and 34D) for receiving bolts (28A & 28B) and nuts (29A & 29B)

FIG. 7 is a side, cut-away view of garage shield, base plate (1) having elongated, L-shaped attachment plate (9) attached to base plate (1) by bolt (31A) and nut (31B). Bolt (28A) and nut (28B) are attachment means for attaching elongated L-shaped attachment plate (9) to garage door arm (7), not shown.

Obviously, many modifications and variations of the invention, as herein before set forth, may be made without departing from the spirit and scope thereof, and therefore only such limitations should be imposed as are indicated in the appended claims.

I claim:

1. A garage door shield attached to a garage door arm with attachment means, wherein the garage shield is a base plate having a rectangular shape, said garage door arm being pivotally attached to garage door at one end and pivotally attached to an emergency release lever housing at the other end, wherein the garage shield is attached to the garage door arm at a distance of from 0.45 inch to 2 inched from the bottom of the emergency release lever housing, said garage shield being positioned between the front of the garage door and the emergency release lever.

2. The garage door shield of claim 1., wherein the base plate contains drilled apart holes for receiving U bolts and nuts.

3. The garage door shield of claim 2. wherein the attachment means is U-bolts positioned around the garage door arm passing through the drilled apart holes, wherein the U-bolts receive nuts to secure the U-bolts and security shield base plate to the garage door arm.

4. The garage door shield of claim 1., wherein the base plate contains an L-shaped stabilizer for positioning against a side of the garage door arm.

5. The garage door shield of claim 1., wherein the attachment means is an elongated L-shaped attachment plate attached to the base plate and containing a plurality of holes, which correspond to a plurality of holes in the garage door arm.

6. The garage door shield of claim 5., wherein the plurality of holes in the L-shaped attachment plate attached to the garage door shield and plurality of holes in the garage door arm receive bolts and nuts to attach the two together.

7. The garage door shield of claim 1., wherein the base plate is constructed from a material selected from the group consisting of metal, plastic, or wood or mixture thereof.

8. The garage door shield of claim 5., wherein the L-shaped structure is attached to the base plate by an adhesive.

9. The garage door shield of claim 5., wherein the L-shaped structure is attached to the base plate by nuts and bolts.

10. The garage door shield of claim 1., wherein the base plate is attached to the garage door arm at an angle of 20° degrees to 90° degrees from vertical.
